(19) United States
(12) Patent Application Publication
(10) Pub. No.: US 2024/0363903 A1
(43) Pub. Date: Oct. 31, 2024

(54) Additive for Electrolyte Solution of Secondary Battery, Method of Preparing the Same, Electrolyte Solution Including the Same and Lithium Secondary Battery Including the Same

(71) Applicants: SK Innovation Co., Ltd., Seoul (KR); SK On Co., Ltd., Seoul (KR)

(72) Inventors: Min Kyung Seon, Daejeon (KR); Hong Won Lee, Daejeon (KR); Jeong Yun Kim, Daejeon (KR); Yu Na Shim, Daejeon (KR)

(21) Appl. No.: 18/647,198

(22) Filed: Apr. 26, 2024

(30) Foreign Application Priority Data
Apr. 27, 2023 (KR) 10-2023-0055562

(51) Int. Cl. H01M 10/0567; H01M 10/052; H01M 10/0568; H01M 10/0585

(52) U.S. Cl. CPC H01M 10/0567; H01M 10/052; H01M 10/0568; H01M 10/0585

(57) ABSTRACT

An additive for an electrolyte solution of a secondary battery includes a microcapsule particle. The microcapsule particle includes a core containing a phosphorus-based flame retardant, and a shell surrounding a surface of the core and including a polymer that includes a urea-derived repeating unit, a formaldehyde-derived repeating unit and a resorcinol-derived repeating unit. An electrolyte solution and a lithium secondary battery including the additive for an electrolyte solution have improved stability, life-span and storage properties at high temperature.

### CROSS-REFERENCE TO RELATED APPLICATION

This application claims priority to Korean Patent Application No. 10-2023-0055562 filed Apr. 27, 2023, the disclosure of which is hereby incorporated by reference in its entirety.

### BACKGROUND OF THE INVENTION

### Field of the Invention

The present disclosure relates to an additive for an electrolyte of a secondary battery, a method of preparing the same, an electrolyte solution comprising the same and a lithium secondary battery comprising the same.

### Description of Related Art

A secondary battery, which can be charged and discharged repeatedly, has been widely employed as a power source of a mobile electronic device such as a camcorder, a mobile phone, a laptop computer, etc., according to developments of information and display technologies. Recently, a battery pack including the secondary battery is being developed and is being applied as a power source of an eco-friendly vehicle such as an electric automobile, a hybrid vehicle, etc.

Examples of the secondary battery include, e.g., a lithium secondary battery, a nickel-cadmium battery, a nickel-hydrogen battery, etc. The lithium secondary battery is actively developed and applied due to high operational voltage and energy density per unit weight, a high charging rate, a compact dimension, etc.

For example, the lithium secondary battery may include an electrode assembly including a cathode, an anode and a separation layer (separator), and an electrolyte solution immersing the electrode assembly. The lithium secondary battery may further include an outer case having, e.g., a pouch shape accommodating the electrode assembly and the electrolyte.

As an application range of the lithium secondary battery is expanded, greater life-span, higher capacity and operation stability are required. Accordingly, a lithium secondary battery capable of providing uniform power and capacity even during repeated charging and discharging is advantageous.

However, power and capacity may be decreased due to, e.g., surface damages of a nickel-based lithium metal oxide used as a cathode active material during repeated charging and discharging, and a side reaction between the nickel-based lithium metal oxide and the electrolyte solution may occur. Further, stability of the battery may be deteriorated in harsh environment of high temperature or low temperature.

### SUMMARY OF THE INVENTION

According to an embodiment of the present invention, there is provided additive for an electrolyte solution of a secondary battery providing improved high temperature property and a method of preparing the same.

According to an embodiment of the present invention, there is provided an electrolyte solution of a lithium secondary battery providing improved high temperature property and a lithium secondary battery including the same.

An additive for an electrolyte solution of a secondary battery comprises a microcapsule particle. The microcapsule particle comprises a core containing a phosphorus-based flame retardant, and a shell surrounding a surface of the core and comprising a polymer that comprises a urea-derived repeating unit, a formaldehyde-derived repeating unit and a resorcinol-derived repeating unit.

In some embodiments, the shell may comprise a urea-formaldehyde-resorcinol terpolymer.

In some embodiments, the phosphorus-based flame retardant may comprise a phosphate-based flame retardant or a phosphazene-based flame retardant.

In some embodiments, the phosphazene-based flame retardant may comprise a compound represented by Chemical Formula 1.

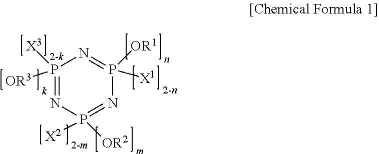

In Chemical Formula 1, X¹ to X³ are each independently Cl, Br or F, R¹ to R³ are each independently a C₁ to C₆ alkyl group or a C₆ to C₂₀ aryl group, and n, m and k are each independently 0, 1 or 2.

In some embodiments, the phosphate-based flame retardant may comprise triphenyl phosphate, trixylenyl phosphate, tricresyl phosphate, triisopropylphenyl phosphate, trischloroethyl phosphate, trischloropropyl phosphate, resorcinyl diphenyl phosphate, phenyl diresorcinyl phosphate, cresyl diphenyl phosphate, xylenyl diphenyl phosphate and/or phenyl di(isopropylphenyl)phosphate.

In some embodiments, a content of the formaldehyde-derived repeating unit in the polymer may be in a range from 20 moles to 100 moles per 1 mole of the resorcinol-derived repeating unit, and a content of the urea-derived repeating unit in the polymer may be in a range from 10 moles to 40 moles per 1 mole of the resorcinol-derived repeating unit.

In some embodiments, a particle diameter of the microcapsule particle may be in a range from 1 μm to 15 μm.

In some embodiments, the shell may have a thickness in a range from 100 nm to 300 nm.

In some embodiments, a content of the core may be in a range from 50 weight percent (wt. %) to 80 wt. %, based on a total weight of the microcapsule particle.

In some embodiments, the polymer may comprise a structure in which linear chains comprising a plurality of the urea-derived repeating units and the resorcinol-derived repeating units are cross-linked by the formaldehyde-derived repeating unit.

In a method of preparing an additive for an electrolyte solution of a secondary battery, a phosphorus-based flame retardant is added to a mixture containing urea and resorcinol to prepare a dispersion. Formaldehyde is added to the dispersion to form microcapsule particles.

In some embodiments, a pH of the mixture may be in a range from 3 to 5.

In some embodiments, in the preparation of the dispersion, preliminary particles that may comprise a core containing the phosphorus-based flame retardant and a preliminary shell containing a urea-resorcinol product formed on the core are formed.

In some embodiments, the preliminary particles may exist in a colloidal state in the dispersion.

In some embodiments, in the formation of the microcapsule particles, the preliminary shell may be converted into a shell by additionally cross-linking the preliminary shell by formaldehyde.

In some embodiments, the formation of the microcapsule particles may be performed at a temperature in a range from 50° C. to 80° C.

An electrolyte solution for a secondary battery comprises an organic solvent, a lithium salt and the additive for an electrolyte solution of a secondary battery according to the embodiments described herein.

In some embodiments, a content of the additive for an electrolyte solution of a secondary battery may be in a range from 1 wt. % to 5 wt. %, based on a total weight of the electrolyte solution.

A lithium secondary battery comprises a case, an electrode assembly including repeatedly stacked cathodes and anodes, and the electrolyte solution for a secondary battery according to the embodiments described herein accommodated together with the electrode assembly in the case.

An electrolyte additive for a secondary battery according to embodiments described herein may comprise a microcapsule particle that comprises a core containing a flame retardant and a shell containing a polymer. The electrolyte solution for a lithium secondary battery comprising the additive may have a flame retardancy, and may physically separate the flame retardant and the electrolyte solution by the polymer shell to prevent deterioration of a battery performance.

The electrolyte additive for a secondary battery according to embodiments described herein may comprise the microcapsule particle comprising a urea-resorcinol-formaldehyde polymer. The urea-resorcinol-formaldehyde polymer of the shell may be stably maintained in a state surrounding the flame retardant core in a driving environment of the battery.

Additionally, the urea-resorcinol-formaldehyde polymer of the shell may be destroyed at a critical temperature to release the flame retardant of the core to prevent a thermal runaway of the battery.

A lithium secondary battery according to embodiments described herein comprises the electrolyte additive for a secondary battery, thereby achieving life-span properties and storage stability at high temperature without substantially degrading an initial performance of the battery.

### BRIEF DESCRIPTION OF THE DRAWINGS

FIG. 1 is a schematic plan view illustrating a secondary battery in accordance with example embodiments.

FIG. 2 is a schematic cross-sectional view illustrating a secondary battery in accordance with example embodiments.

FIG. 3 is a SEM image of a microcapsule prepared in Example 1.

FIG. 4 is an EDS element mapping image of a cross-section of a microcapsule in Example 1.

FIG. 5 is an EDS element mapping image of a cross-section of a microcapsule in Example 1.

### DESCRIPTION OF THE INVENTION

According to embodiments described herein, an electrolyte additive for a secondary battery comprising a microcapsule particle that comprises a core and a shell is provided. Additionally, an electrolyte solution for a lithium secondary battery and a lithium secondary battery comprising the additive and having improved high temperature properties are also provided.

Hereinafter, the present invention will be described in detail with reference to the accompanying drawing. However, those skilled in the art will appreciate that such embodiments described with reference to the accompanying drawing are provided to further understand the spirit of the present invention and do not limit subject matters to be protected as disclosed in the detailed description and appended claims.

Furthermore, throughout the disclosure, unless otherwise particularly stated, the word “comprise”, “include”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present disclosure comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present disclosure. Unless otherwise defined in the present disclosure, values which may be outside a numerical range due to experimental error or rounding off of a value are also comprised in the defined numerical range.

For the purposes of this disclosure, unless otherwise indicated, all numbers expressing quantities of ingredients, reaction conditions, dimensions, physical characteristics, and so forth used in the disclosure are to be understood as being modified in all instances by the term “about.” Hereinafter, unless otherwise particularly defined in the present disclosure, “about” may be considered as a value within 30%, 25%, 20%, 15%, 10%, 5%, 3%, 2%, 1%, 0.5%, 0.1%, 0.05% or 0.01% of a stated value. Unless indicated to the contrary, the numerical parameters set forth in this disclosure are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, “formed from” or “prepared from” denotes open, e.g., “comprising,” claim language. As such, it is intended that a composition “formed from” or “prepared from” a list of recited components be a composition comprising at least these recited components or the reaction product of at least these recited components, and can further comprise other, non-recited components, during the composition's formation or preparation. As used herein, the phrase “reaction product of” means chemical reaction product(s) of the recited components, and can include partial reaction products as well as fully reacted products.

The term “Cₐ to C_{b}” used herein refers to the number of carbon atoms in a functional group, which is in a range from a to b, where a and b are integers.

The electrolyte additive for a secondary battery (hereinafter, abbreviated as “additive”) according to embodiments described herein may comprise a microcapsule particle. The additive may comprise a plurality of the microcapsule particles. For example, an amount of the microcapsule particles may be 50 weight percent (wt. %) or more, based on a total weight of the additive. In some embodiments, the amount of the microcapsule particles may be 60 wt. % or more, 70 wt. % or more, 80 wt. % or more, or 90 wt. % or more, based on the total weight of the additive.

In an embodiment, the additive may substantially consist of the microcapsule particles.

The microcapsule particle may have a core and a shell surrounding a surface of the core. The shell may surround an entire outer surface of the core.

The core may comprise a phosphorus-based flame retardant. The phosphorus-based flame retardant may stabilize free radicals generated during charging and discharging of the battery. Accordingly, combustion and explosion inside the secondary battery, due to a reaction of the free radicals, may be prevented.

In some embodiments, the phosphorus-based flame retardant may comprise a phosphate-based flame retardant or a phosphazene-based flame retardant. In some embodiments, the phosphorus-based flame retardant may comprise both the phosphate-based flame retardant and the phosphazene-based flame retardant.

In some embodiments, the phosphazene-based flame retardant may comprise a compound represented by Chemical Formula 1.

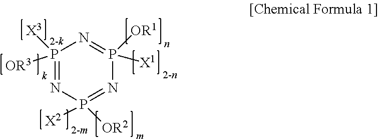

In Chemical Formula 1, X¹ to X³ may each independently be a halogen atom, e.g., Cl, Br or F, and may be the same or may be different from each other.

In Chemical Formula 1, R¹ to R³ may each independently be a C₁ to C₆ alkyl group or a C₆ to C₂₀ aryl group. In some embodiments, R¹ to R³ may be the same or may be different from each other.

The alkyl group and the aryl group may be unsubstituted or substituted. The term “substituted” may refer that any hydrogen bonded to a carbon atom of a hydrocarbon group is substituted with at least one substituent. Examples of the substituent include a halogen atom, a C₁ to C₆ alkyl group, a C₂ to C₆ alkenyl group, a C₂ to C₆ alkynyl group, a C₁ to C₆ alkoxy group, a vinyl group, a hydroxy group, a primary to tertiary amine group, an imine group, a thiol group, a sulfide group, etc.

The “alkyl group” is an aliphatic saturated hydrocarbon group and may be linear or branched.

The term “aryl group” may indicate a substituent including an aromatic ring that may have a single ring structure or a multiple ring structure. Examples of the aryl group includes a phenyl group.

In Chemical Formula 1, n, m and k may each independently be 0, 1 or 2, and may be the same or may be different from each other.

The phosphorus-based flame retardant may comprise at least one selected from the group consisting of triphenyl phosphate, trixylenyl phosphate, tricresyl phosphate, triisopropylphenyl phosphate, trischloroethyl phosphate, trischloropropyl phosphate, resorcinol diphenyl phosphate, phenyl diresorcinyl phosphate, cresyl diphenyl phosphate, xylenyl diphenyl phosphate and phenyl di(isopropylphenyl)phosphate.

In some embodiments, the phosphorus-based flame retardant may comprise at least one selected from the group consisting of triphenyl phosphate, trixylenyl phosphate, tricresyl phosphate, cresyl diphenyl phosphate and xylenyl diphenyl phosphate.

According to some embodiments, the shell may comprise a polymer, and the polymer may comprise a urea-derived repeating unit, a formaldehyde-derived repeating unit, and a resorcinol-derived repeating unit.

According to some embodiments, the shell may comprise a urea-formaldehyde-resorcinol terpolymer.

Urea, formaldehyde and resorcinol may be represented by Chemical Formulas 2 to 4, respectively.

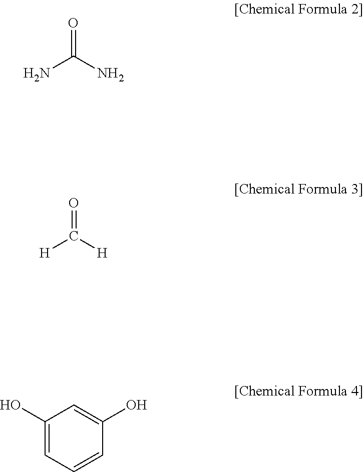

An amine group of the urea, a carbonyl group of formaldehyde and a hydroxy group of resorcinol may be bonded through a reaction to form a repeating unit of the polymer. For example, the amine group of the urea and the hydroxy group of the resorcinol may react to form an amide group, and the carbonyl group of formaldehyde may combine with two nitrogen groups of the urea to form a carbamide group (—NH—C(═O)—NH—).

In some embodiments, in an aromatic ring of resorcinol, a direct bond may be formed at a carbon atom to which a hydroxyl group is not bonded.

In some embodiments, the polymer may have a structure in which linear chains comprising a plurality of the urea-derived repeating units and the resorcinol repeating units are cross-linked by the formaldehyde-derived repeating unit. Urea and resorcinol may be mixed and polymerized in advance to form a polymer chain, and the formaldehyde may be added to form an interchain cross-linked bond to form the cross-linked structure. For example, formaldehyde may form a cross-linked bond by combining nitrogen atoms of the urea-derived repeating unit comprised in a plurality of the linear chains.

In some embodiments, the linear chains may be connected to the formaldehyde-derived repeating units in a length direction.

In some embodiments, a content of the formaldehyde-derived repeating unit in the polymer may be in a range from 20 moles to 100 moles with respect to 1 mole of the resorcinol-derived repeating unit.

In some embodiments, the content of the formaldehyde-derived repeating unit in the polymer may be in a range from 90 moles to 100 moles with respect to 1 mole of the resorcinol-derived repeating unit.

In some embodiments, a content of the urea-derived repeating unit in the polymer may be in a range from 10 moles to 40 moles with respect to 1 mole of the resorcinol-derived repeating unit.

In some embodiments, the content of the urea-derived repeating unit in the polymer may be in a range from 15 moles to 25 moles with respect to 1 mole of the resorcinol-derived repeating unit.

In the above-content ranges, the polymer comprising a structure in which a linear chain comprising a copolymer of urea and resorcinol is crosslinked or connected in the length direction with the formaldehyde-derived repeating unit may be formed. The polymer having the above-described structure may have enhanced thermal stability, thereby improving high-temperature stability of the electrolyte solution.

In some embodiments, a particle diameter of the microcapsule particle may be in a range from 1 μm to 15 μm. In some embodiments, the particle diameter of the microcapsule particle may be in a range from 3 to 13 μm.

According to some embodiments, a maximum particle diameter of the microcapsule particle may be 10 μm to 15 μm, and a minimum particle diameter may be 0.5 μm to 7 μm.

In some embodiments, an average particle diameter of the microcapsule particles may be in a range from 1 μm to 10 μm. In some embodiments, the average particle diameter of the microcapsule particles may be in a range from 3 μm to 9 μm. The average particle diameter may be determined by, e.g., a light scattering or laser (LASER) diffraction method or electroacoustic spectroscopy.

In the above particle diameter ranges of the microcapsule particles, when the internal temperature of the battery is rapidly increased due to a large surface area, the shell may be ruptured to emit the internal flame retardant in an amount sufficient to prevent a combustion.

In some embodiments, a thickness of the shell may be in a range from 100 nm to 300 nm. In some embodiments, the thickness of the shell may be in a range from 150 nm to 250 nm. In the above thickness ranges of the shell, the core comprising the flame retardant may be physically separated from the electrolyte solution and rapidly ruptured at a critical temperature to release the flame retardant.

In some embodiments, a content of the core may be in a range from 50 weight percent (wt. %) to 80 wt. %, based on a total weight of the microcapsule particle. In some embodiments, the content of the core may be 60 wt. % to 70 wt. %, based on the total weight of the microcapsule particle.

In the above content ranges of the core in the microcapsule particle, a sufficient amount of flame retardant emitted by decomposing the polymer shell may be obtained when an internal temperature of the battery is increased due to a heat generation or external factors due to charging and discharging of the battery.

Hereinafter, a method of preparing the electrolyte additive for a secondary battery according to embodiments described herein is also described.

In some embodiments, a mixture comprising urea and resorcinol may be prepared. The mixture may be prepared by adding urea and resorcinol to a solvent.

The solvent may not be particularly limited, and may comprise an aqueous solvent. For example, the solvent may comprise water.

The mixture may comprise 10 moles to 40 moles of urea based on 1 mole of resorcinol. In some embodiments, the mixture may comprise 15 moles to 25 moles of urea based on 1 mole of resorcinol.

A total weight of urea and resorcinol in the mixture may be 1 part by weight to 5 parts by weight, based on 100 parts by weight of the solvent.

In some embodiments, a pH of the mixture may be in a range from 3 to 5. In the pH range, the polymerization reaction of urea and resorcinol may be facilitated.

In some embodiments, the mixture may further comprise at least one additive selected from the group consisting of an acidity regulator, a surfactant and a stabilizer.

The mixture may comprise the acidity regulator. The acidity regulator may be added to lower the pH so that the polymerization reaction of urea and resorcinol may be induced in an acidic environment. The acidity regulator may comprise a compound that may be dissolved in a solvent to dissociate into an acidic salt. For example, the acidity regulator may be a basic compound, and may comprise a metal hydroxide, such as sodium hydroxide and/or potassium hydroxide, an amine-based compound, such as triethanolamine, etc. These may be used alone or in a combination of two or more thereof.

The acidity regulator may be added in an appropriate amount so that the pH of the mixture may be in the range of 3 to 5.

The mixture may comprise the surfactant. The surfactant may be added to stably form a robust polymer shell on a surface of the flame retardant core. The surfactant may comprise, e.g., an ethylene-maleic anhydride polymer.

The mixture may comprise the stabilizer. The mixture may be further stabilized by the stabilizer in the polymerization of the urea-formaldehyde-resorcinol copolymer. Further, the stabilizer may improve mechanical strength, and physical and chemical stability of the shell of the microcapsule. The stabilizer may comprise, e.g., ammonium chloride, sodium chloride, etc.

The mixture may comprise the surfactant in an amount of 0.1 parts by weight to 10 parts by weight, based on 100 parts by weight of the solvent.

The mixture may be pre-heated for dissolution of the added components and polymerization of urea and resorcinol. A temperature of the mixture may be increased from room temperature to about 40° C. to about 70° C. by the pre-heating.

A phosphorus-based flame retardant may be added to the mixture to prepare a dispersion. The phosphorus-based flame retardant may be added in a solid form of particles, or may be added in a liquid form.

If the phosphorus-based flame retardant is added to the mixture in the liquid form, the phosphorus-based flame retardant may be dispersed in the form of a colloid. For example, the phosphorus-based flame retardant agglomerated in the form of the colloid may be present in the dispersion.

In some embodiments, the phosphorus-based flame retardant may be added to the mixture in an amount of 1 milliliters (ml) to 15 ml, based on 100 ml of the solvent of the mixture. Alternatively, the phosphorus-based flame retardant may be added to the mixture in an amount of 1 parts by weight to 15 parts by weight, based on 100 parts by weight of the solvent of the mixture.

If the phosphorus-based flame retardant is added to the mixture in the above content range, the phosphorus-based flame retardant may be uniformly dispersed in the colloidal form and a particle-shaped microcapsule may be formed.

The dispersion may be prepared by adding the phosphorus-based flame retardant to the mixture and then homogenizing the mixture at a stirring rate of 10,000 rpm to 15,000 rpm. When homogenizing at the stirring rate in the above range, the phosphorus-based flame retardant may form a colloid having a more uniform size. The dispersion may be prepared in the form of an emulsion by the homogenization.

The homogenization may be performed for 1 minute to 10 minutes.

The dispersion may comprise a preliminary particle having a micelle structure that may comprise a core comprising the phosphorus-based flame retardant and a preliminary shell comprising a urea-resorcinol product formed on the core.

The preliminary particle may exist in the dispersion as a colloidal state.

Formaldehyde may be added to the dispersion to form microcapsule particles. The dispersion may comprise the phosphorus-based flame retardant dispersed in the colloidal form and a polymer chain formed by the polymerization of urea and resorcinol. Further, the dispersion may comprise the preliminary particles including the phosphorus-based flame retardant core and the preliminary shell comprising the urea-resorcinol product.

Formaldehyde may be added to the dispersion, so that microcapsule particles may be formed by the formation of a shell containing a urea-resorcinol-formaldehyde polymer on the surface of the aggregated phosphorus-based flame retardant.

In the formation of the microcapsule particles, the preliminary shell may be additionally cross-linked with formaldehyde to be converted into the shell. The preliminary shell may be formed by a weak bond of the urea-resorcinol product. Formaldehyde may be added to the dispersion to further cross-link the preliminary shell to form the shell.

In some embodiments, the formation of the microcapsule particles may be performed at a temperature of 50° C. to 80° C. The formation of the microcapsule particles may be performed without ramping of the temperature after adding formaldehyde to the dispersion. In some embodiments, formaldehyde may be added to the dispersion, and then ramping of the temperature may be performed to obtain the temperature within the above range to form the microcapsule particles.

In some embodiments, formaldehyde may be added to the dispersion, and then the dispersion may be stirred for 1 hour to 4 hours to form the microcapsule particles.

The dispersion, in which the microcapsule particles are formed, may be cooled and filtered to obtain the microcapsule particles. In some embodiments, after the filtration, the microcapsule particles may be obtained by a plurality of washings with a solvent, e.g., distilled water.

The electrolyte solution for a lithium secondary battery (hereinafter, abbreviated as an “electrolyte solution”) according to embodiments described herein may comprise the electrolyte additive for a secondary battery described herein. The electrolyte solution may further comprise an organic solvent and a lithium salt.

In example embodiments, a content of the electrolyte additive may be in a range from 1 wt. % to 5 wt. %, based on a total weight of the electrolyte solution. In some embodiments, the content of the electrolyte additive may be in a range from 2 wt. % to 4 wt. %, based on the total weight of the electrolyte solution.

In the above content ranges, a lithium secondary battery having improved high-temperature stability of the electrolyte and improved high-temperature storage and life-span properties may be efficiently implemented.

In some embodiments, the organic solvent may be used in a residual amount or as a remainder, excluding the lithium salt, the additive, an auxiliary additive, etc. A content of the organic solvent may be 90 parts by weight to 96 parts by weight, based on the total weight of the electrolyte solution.

The organic solvent may comprise an organic compound that may provide sufficient solubility for the lithium salt, a triphenyl phosphate-based additive, an auxiliary additive, etc. while having no reactivity with the lithium secondary battery. In some embodiments, a non-aqueous organic solvent may be used, and the electrolyte solution may be provided as a non-aqueous electrolyte solution.

In example embodiments, the organic solvent may comprise a carbonate-based solvent, an ester-based solvent, an ether-based solvent, an alcohol-based solvent, an aprotic solvent, etc. These may be used alone or in a combination of two or more thereof.

Examples of the carbonate-based solvent include dimethyl carbonate (DMC), ethyl methyl carbonate (EMC), methyl propyl carbonate, ethyl propyl carbonate, diethyl carbonate (DEC), dipropyl carbonate, propylene carbonate (PC), ethylene carbonate (EC), fluoroethylene carbonate (FEC), butylene carbonate etc.

Examples of the ester-based solvent include methyl acetate (MA), ethyl acetate (EA), n-propyl acetate (n-PA), 1,1-dimethylethyl acetate (DMEA), methyl propionate (MP), ethyl propionate (EP), gamma-butyrolacton (GBL), decanolide, valerolactone, mevalonolactone, caprolactone, etc.

Examples of the ether-based organic solvent include dibutyl ether, tetraethylene glycol dimethyl ether (TEGDME), diethylene glycol dimethyl ether (DEGDME), dimethoxy ethane, 2-methyltetrahydrofuran, tetrahydrofuran, etc.

The aprotic solvent may include a nitrile-based solvent, an amide-based solvent, such as dimethyl formamide (DMF), a dioxolane-based solvent, such as 1,3-dioxolane, a sulfolane-based solvent, etc.

In some embodiments, the carbonate-based solvent may be used as the organic solvent. For example, the organic solvent may comprise ethylene carbonate (EC), ethyl methyl carbonate (EMC), dimethyl carbonate (DMC), diethyl carbonate (DEC), or a combination thereof.

In some embodiments, a combination of at least two of ethylene carbonate (EC), ethyl methyl carbonate (EMC), dimethyl carbonate (DMC) and diethyl carbonate (DEC) may be used as the organic solvent.

In some embodiments, the organic solvent may not comprise a ketone-based solvent. If the organic solvent contains a ketone-based solvent, the microcapsule particles may be damaged and the flame retardant may be dissolved in the electrolyte solution even at a temperature below a critical temperature. In this case, stability of the electrolyte solution may be lowered and battery performance may be degraded.

The lithium salt may be included in the electrolyte solution in an amount ranging from 0.01 wt. % to 5 wt. %, based on a total weight of the electrolyte solution, or from 0.1 wt. % to 2 wt. %. In some embodiments, a content of the lithium salt in the electrolyte solution may be in a range from 0.01 Molar (M) to 5 M. Within the above ranges, transfer of lithium ions and/or electrons may be promoted during charging and discharging of the lithium secondary battery, and improved capacity may be provided.

The lithium salt may be expressed as Li⁺X⁻, and non-limiting examples of anions (X−) of the lithium salt include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃—, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂, SCN⁻, (CF₃CF₂SO₂)₂N⁻, etc. These may be used alone or in a combination of two or more thereof.

In some embodiments, the electrolyte solution may further comprise an auxiliary additive. The auxiliary additive may be included in the electrolyte solution in an amount ranging from 0.01 wt. % to 5 wt. %, based on the total weight of the electrolyte solution, or from 0.1 wt. % to 4 wt. %.

For example, the auxiliary additive may comprise an unsaturated cyclic carbonate-based compound, a fluorine-substituted cyclic carbonate-based compound, a sultone-based compound, a cyclic sulfate-based compound, an oxalatophosphate-based compound, etc.

The unsaturated cyclic carbonate-based compound may comprise vinyl ethylene carbonate (VEC). Additionally, the unsaturated cyclic carbonate-based compound may comprise vinylene carbonate (VC).

The fluorine-substituted cyclic carbonate-based compound may comprise fluoroethylene carbonate (FEC).

The sultone-based compounds may comprise 1,3-propane sultone, 1,3-propene sultone, 1,4-butane sultone, etc.

The cyclic sulfate-based compound may comprise 1,2-ethylene sulfate, 1,2-propylene sulfate, etc.

The oxalatophosphate-based compound may comprise lithium difluoro bis(oxalato)phosphate.

In some embodiments, the auxiliary additive may comprise the fluorine-substituted cyclic carbonate-based compound, the sultone-based compound, the cyclic sulfate-based compound and the oxalatophosphate-based compound.

Durability and stability of the electrode may be further improved by the auxiliary additive. The auxiliary additive may be included in the electrolyte solution in an appropriate amount within a range that does not inhibit the transfer of lithium ions in the electrolyte solution.

Embodiments of the present disclosure provide a lithium secondary battery containing the electrolyte solution described herein.

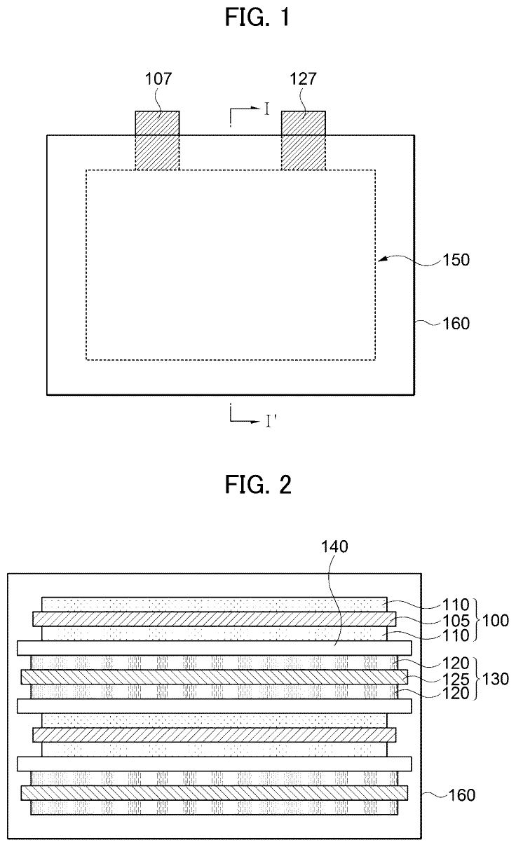

FIGS. 1 and 2 are a schematic plan view and a cross-sectional view, respectively, illustrating a lithium secondary battery in accordance with example embodiments. For example, FIG. 2 is a cross-sectional view taken along a line I-I′ of FIG. 1.

Referring to FIGS. 1 and 2, the lithium secondary battery may comprise an electrode assembly including a cathode 100, an anode 130 and a separator 140 interposed between the cathode 100 and the anode 130.

The electrode assembly may be accommodated with the electrolyte solution described herein in a case 160 to be impregnated with the electrolyte solution.

The cathode 100 may comprise a cathode active material layer 110 formed by coating a cathode active material on a cathode current collector 105. The cathode active material may comprise a compound capable of reversibly intercalating and de-intercalating lithium ions.

In some embodiments, the cathode active material may comprise a lithium-transition metal oxide. For example, the lithium-transition metal oxide may comprise nickel (Ni), and may further comprise at least one of cobalt (Co) or manganese (Mn).

For example, the lithium-transition metal oxide may be represented by Chemical Formula 5 below.

Li₁₊ₐNi_{1-(x+y)}CoₓM_{y}O₂ [Chemical Formula 5]

In Chemical Formula 5, −0.05≤a≤0.2, 0.01≤x≤0.3, 0.01≤y≤0.3, and M may include at least one element selected from Mn, Mg, Sr, Ba, B, Al, Si, Ti, Zr and/or W.

As represented in Chemical Formula 5, the lithium-transition metal compound may contain Ni in a highest content or a highest molar ratio among Ni, Co and M. Ni may substantially serve as a metal related to a power and/or a capacity of the lithium secondary battery. Ni may be employed in the largest amount among transition metals, so that a high-capacity and high-power lithium secondary battery may be implemented.

In some embodiments, in Chemical Formula 5, 0.01≤x≤0.2 and 0.01≤y≤0.2. In some embodiments, the molar ratio of Ni may be 0.7 or more, or 0.8 or more.

If the Ni content in the cathode active material or the lithium-transition metal oxide increases, chemical stability, e.g., high-temperature storage stability of the secondary battery may be relatively deteriorated. Further, sufficient high power/high capacity properties from the high Ni content may not be provided due to surface damages of the cathode active material or side reactions with the electrolyte solution during repeated charging/discharging.

A slurry may be prepared by mixing and stirring the cathode active material with a binder, a conductive material and/or a dispersant in a solvent. The slurry may be coated on the cathode current collector 105, and then dried and pressed to prepare the cathode 100.

The cathode current collector 105 may comprise, e.g., stainless steel, nickel, aluminum, titanium, copper, or an alloy thereof, and may comprise, e.g., aluminum or an aluminum alloy.

The binder may comprise, e.g., an organic binder, such as a vinylidene fluoride-hexafluoropropylene copolymer (PVDF-co-HFP), polyvinylidene fluoride (PVDF), polyacrylonitrile, polymethylmethacrylate, etc., or an aqueous binder, such as styrene-butadiene rubber (SBR), and may be used with a thickener, such as carboxymethyl cellulose (CMC).

For example, a PVDF-based binder may be used as the cathode binder. In this case, an amount of the binder for forming the cathode active material layer may be reduced, and an amount of the cathode active material may be relatively increased. Thus, capacity and power of the lithium secondary battery may be further improved.

The conductive material may be added to facilitate electron mobility between active material particles. For example, the conductive material may comprise a carbon-based material, such as graphite, Super-P, carbon black, graphene, carbon nanotube, etc., and/or a metal-based material such as tin, tin oxide, titanium oxide, a perovskite material, such as LaSrCoO₃ or LaSrMnO₃, etc.

The anode 130 may comprise an anode current collector 125 and an anode active material layer 120 formed by coating an anode active material on the anode current collector 125.

The anode active material may comprise a material widely known in the related art which may be capable of intercalating and de-intercalating lithium ions without a particular limitation. For example, a carbon-based material, such as a crystalline carbon, an amorphous carbon, a carbon composite, a carbon fiber, etc., a lithium alloy, silicon (Si)-based compounds or tin may be used.

Examples of the amorphous carbon may include hard carbon, coke, mesocarbon microbead (MCMB), mesophase pitch-based carbon fiber (MPCF), etc.

Examples of the crystalline carbon may include a graphite-based carbon such as natural graphite, artificial graphite, graphitized coke, graphitized MCMB, graphitized MPCF, etc.

Elements included in the lithium alloy may include aluminum, zinc, bismuth, cadmium, antimony, silicon, lead, tin, gallium, indium, etc.

The silicon-based compound may comprise, e.g., silicon, a silicon oxide or a silicon-carbon composite compound, such as silicon carbide (SiC).

For example, an anode slurry may be prepared by mixing and stirring the anode active material with the binder described herein, the conductive material described herein, the thickener described herein, etc., in a solvent. The anode slurry may be coated on at least one surface of the anode current collector 125, and then dried and pressed and dried to form the anode 130.

The separator 140 may be interposed between the cathode 100 and the anode 130. The separator 140 may comprise a porous polymer film prepared from, e.g., a polyolefin-based polymer, such as an ethylene homopolymer, a propylene homopolymer, an ethylene/butene copolymer, an ethylene/hexene copolymer, an ethylene/methacrylate copolymer, or the like. The separator 140 may also comprise a non-woven fabric formed from a glass fiber with a high melting point, a polyethylene terephthalate fiber, etc.

In some embodiments, an area (e.g., a contact area with the separator 140) and/or a volume of the anode 130 may be larger than that of the cathode 100. Accordingly, transfer of the lithium ions generated from the cathode 100 may be promoted to the anode 130 without a precipitation.

In some embodiments, an electrode cell may be defined by the cathode 100, the anode 130 and the separator 140, and a plurality of the electrode cells may be stacked to form the electrode assembly 150 that may have e.g., a jelly roll shape. For example, the electrode assembly 150 may be formed by winding, stacking or folding of the separator 140.

The electrode assembly 150 may be accommodated together with the electrolyte solution according to the embodiments described herein in the case 160 to define the lithium secondary battery.

As illustrated in FIG. 1, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

The lithium secondary battery may be fabricated into a cylindrical shape using a can, a prismatic shape, a pouch shape, a coin shape, etc.

Hereinafter, exemplary experimental examples are proposed to more concretely describe the present disclosure. However, the following examples are only given for illustrating the present invention and those skilled in the related art will obviously understand that various alterations and modifications are possible within the scope and spirit of the present invention. Such alterations and modifications are duly included in the appended claims.

### Example 1

### Preparation of Microcapsules

100 g of water, 2.5 g of urea (0.0416 mol), 0.25 g of resorcinol (0.00227 mol), 0.25 g of ammonium chloride, 50 ml of an ethylene-maleic anhydride polymer solution (2.5 wt. % of solid content) was added to a round-bottom flask, and heated to 50° C. Thereafter, a pH of the mixture was adjusted to 3.5 by adding triethanolamine. Thereafter, 5.5 ml of triphenyl phosphate (TPP) was added to the mixture and emulsified by homogenizing at a stirring rate of 13,000 rpm for 5 minutes to prepare a dispersion.

6.3 g (0.210 mol) of formaldehyde was added to the dispersion, and then heated to 55° C. and stirred for 2 hours to complete the reaction. After the reaction, the dispersion was cooled, filtered, and then repeatedly washed with distilled water to obtain microcapsules.

### Preparation of Electrolyte Solution

A 1.0 M LiPF₆ solution (EC/EMC mixed solvent having a volume ratio of 25:75) was prepared. In the LiPF₆ solution, 1 wt. % of fluoroethylene carbonate (FEC), 0.5 wt. % of 1,3-propane sultone (PS), 1 wt. % of 1,3-propene sultone (PRS), 0.5 wt. % of ethylene sulfate (ESA) and 1.0 wt. % of lithium difluorobis(oxalato) phosphate (W3) were added thereto, and 2.5 wt. % of the microcapsules prepared in Example 1 was added thereto.

### Fabrication of Lithium Secondary Battery Sample

A cathode active material in which Li[Ni_{0.6}Co_{0.2}Mn_{0.2}]O₂ and Li[Ni_{0.8}Co_{0.1}Mn_{0.1}]O₂ were mixed in a weight ratio of 6:4, carbon black as a conductive material and polyvinylidene fluoride (PVdF) as a binder were mixed in a weight ratio of 92:5:3. The slurry was uniformly coated on an aluminum foil having a thickness of 15 μm, and vacuum dried and pressed at 130° C. to prepare a cathode for a lithium secondary battery.

95 wt. % of an anode active material in which artificial graphite and natural graphite were mixed in a weight ratio of 7:3, 1 wt. % of Super-P as a conductive material, 2 wt. % of styrene-butadiene rubber (SBR) as a binder, and 2 wt. % of carboxymethyl cellulose (CMC) as a thickener were mixed to prepare an anode slurry. The anode slurry was uniformly coated on a copper foil having a thickness of 15 μm, and then dried and pressed to prepare an anode.

The anode slurry was uniformly coated on a region of a copper foil (15 μm thick) having a protrusion (an anode tab) on one side thereof except on the protrusion, dried, and roll pressed to prepare an anode.

The cathode and the anode manufactured as described above were cut into predetermined sizes and stacked, and a separator (polyethylene, thickness: 20 μm) was interposed between the cathode and the anode to form an electrode assembly, and then tab portions of the cathode and the anode were welded.

The electrode assembly was placed in a pouch, and three sides were sealed except for an electrolyte injection side. Regions where the tab portions are located were included in the sealing portion. The above-prepared electrolyte solution was injected through the electrolyte injection side, and the electrolyte injection side was also sealed. Thereafter, impregnation was performed for 12 hours or more to prepare a 2 Ah lithium secondary battery sample.

### Comparative Example 1

An electrolyte solution and a lithium secondary battery sample were prepared by the same method as that in Example 1, except that 5 wt. % of triphenylphosphate was added in the electrolyte solution instead of 2.5 wt. % of the microcapsule.

### Comparative Example 2

An electrolyte solution and a lithium secondary battery sample were prepared by the same method as that in Example 1, except that the microcapsule was not introduced in the electrolyte solution.

### Experimental Example 1: SEM-EDS Analysis of Microcapsule

A scanning electron microscope (SEM) image of the microcapsule manufactured in Example 1 was obtained, and a cross-sectional element distribution of the microcapsule manufactured in Example 1 was analyzed by an energy dispersive spectroscopy (EDS).

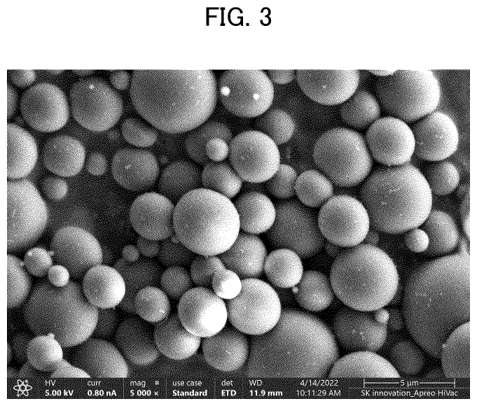

FIG. 3 is an SEM image of a microcapsule prepared in Example 1.

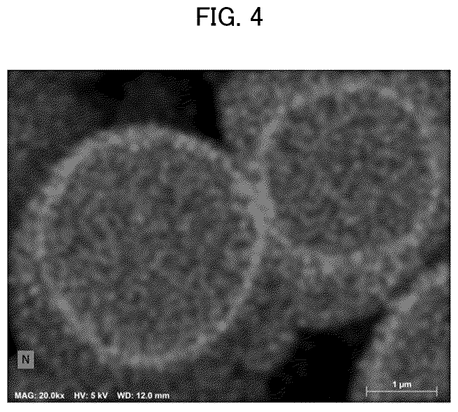

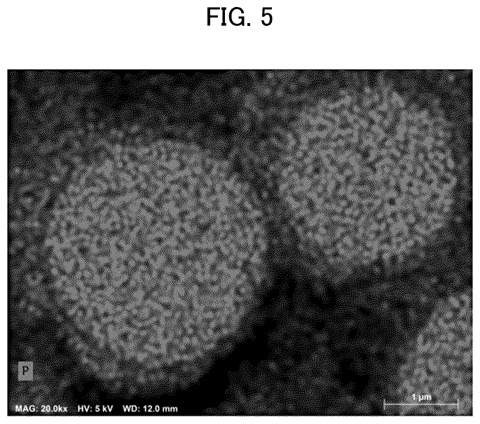

FIGS. 4 and 5 are EDS element mapping images nitrogen (N) and phosphorus (P) of a cross-section of a microcapsule in Example 1.

As shown in to FIG. 3, spherical microcapsules were formed, and a particle diameter was in a range from about 5.302 μm to 11.30 μm.

Referring to FIGS. 4 and 5, it was confirmed that individual microcapsule particle of Example 1 contained phosphorus and nitrogen. Particularly, the microcapsule particle of Example 1 contained nitrogen in a relatively high content at a surface portion and phosphorus in a relatively high content at a central portion.

Accordingly, it was confirmed that the central portion of the particle included triphenyl phosphate, and a coating layer of the particle included a urea-resorcinol-formaldehyde polymer. In FIG. 4, it appears that nitrogen was included in the central portion of the microcapsule particle, but this indicated a signal from a shell behind the capsule cross section. In FIG. 5, it appears that a small amount of phosphorus was also included in the coating layer of the microcapsule particle, but this indicated a signal from unreacted triphenyl phosphate partially remaining at an outside of the coating layer.

### Experimental Example 2: Evaluation on Battery Properties

### (1) Heat Exposure Measurement (Hot Box Test)

The secondary batteries of the Examples and the Comparative Examples of 100% SOC (State Of Charge) were put in an oven, heated from 25° C. by 5° C./min (a 30-minute test at ramping) to reach 150° C., and then left at a temperature of 150° C. to measure a time (delay time) taken until a battery cell exploded.

### (2) Evaluation on Initial Properties

### 2-1) Initial Capacity Evaluation

The secondary batteries of the Examples and the Comparative Examples were charged with 0.5C-rate CC/CV (4.2V, 0.05C cut-off) at 25° C., and then 0.5C-rate CC discharged (2.7V cut-off) to measure a discharge capacity.

### 2-2) Evaluation on Internal Resistance (DCIR)

The C-rate was increased to 0.2C, 0.5C, 1.0C, 1.5C, 2.0C, 2.5C, and 3.0C at an SOC 60% point, and end points of a voltage were configured as a straight line equation when the charging and discharging of the corresponding C-rate were performed for 10 seconds, and a slope was adopted as a DCIR (Direct Current Internal Resistance).

### (3) Evaluation on High Temperature Life-Span Property

3-1) Evaluation on Capacity Retention Rate (Ret) after Repeated High-Temperature Charging and Discharging

The secondary batteries of the Examples and the Comparative Examples were charged with 1C-rate CC/CV at 45° C. and discharged with 1C-rate CC as one cycle for 600 cycles. Thereafter, a discharge capacity was measured.

A capacity retention was calculated as a percentage of the discharge capacity after the 600 cycles relative to the initial capacity measured in 2-1).

3-2) Evaluation on Internal Resistance (DCIR) after Repeated High-Temperature Charging and Discharging

Internal resistances of the secondary batteries of the Examples and the Comparative Examples after the repeated high-temperature charge and discharge were measured by the same method as that in 2-2).

### (4) Evaluation on High Temperature Storage Property

4-1) Evaluation on Capacity Retention (Ret) after High Temperature Storage

The secondary batteries of the Examples and the Comparative Examples at a 100% SOC state were stored at a temperature of 60° C. for 10 weeks.

The secondary batteries of the Examples and the Comparative Examples stored at the high temperature as described above were discharged by 0.5C-rate CC (2.7 V cut-off), and then a discharge capacity was measured.

A capacity retention was calculated as a percentage of the discharge capacity after the high-temperature storage relative to the initial capacity measured in 3-1).

4-2) Evaluation on Internal Resistance (DCIR) Change Ratio after High Temperature Storage

Internal resistances of the secondary batteries of the Examples and the Comparative Examples after the high-temperature storage were measured by the same method as in 2-2).

A change ratio of the measured internal resistance after the high temperature storage relative to the initial internal resistance measured in 2-2) was calculated as a percentage.

The evaluation results of Experimental Example 2 are shown in Table 1 below.

TABLE 1

| | | | Comparative | Comparative |
|---|---|---|---|---|
| | | Example 1 | Example 1 | Example 2 |
| heat | explosion | 150° C. | 150° C. | <150° C. |
| exposure | temperature (° C.) | | | |
| | delay time (min) | 1 | 2.2 | — |
| initial | capacity, mAh | 1759.4 | 1734.5 | 1753.9 |
| property | DCIR, mΩ | 37.5 | 39 | 35.4 |
| high | capacity | 79 | 82 | 78 |
| temperature | retention (%) | | | |
| life-span | DCIR, mΩ | 31.2 | 33.4 | 31.8 |
| high | capacity | 91 | 90 | 90 |
| temperature | retention (%) | | | |
| storage | DCIR change | 7% | 11% | 11% |
| | ratio (%) | | | |

Referring to Table 1 above, the battery of Example 1 was stable at high temperature during the heat exposure, and performance degradation of the cell was suppressed at high temperature. Specifically, the battery of Example 1 did not explode for 1 minute even at 150° C. in the heat exposure evaluation. Additionally, even after being stored at high temperature for a long period, the change ratio of the internal resistance was lowered, and the internal resistance was significantly reduced during the repeated charging and discharging at high temperature.

Particularly, the battery of Example 1 had a lower resistance after the repeated charging and discharging at high temperature than that from the battery of Comparative Example 1, which used an electrolyte solution that included triphenyl phosphate that was not embedded in the microcapsule, thereby improving high-temperature life-span properties.

When evaluating the thermal exposure of the battery of Comparative Example 1, the stability was similar to that of the Example that was provided, but the internal resistance properties of the cell were degraded after being stored at high temperature for a long period.

The battery of Comparative Example 2 did not contain the flame retardant, and the high-temperature stability was explicitly deteriorated compared to that of the battery of Comparative Example 1. Particularly, in the heat exposure evaluation, the battery of Comparative Example 2 exploded before reaching 150° C. by ramping the temperature.

The above-provided Examples are merely examples of applying the concepts of the present disclosure, and other elements may be further included without departing from the scope of the present disclosure.

What is claimed is:

1. An additive for an electrolyte solution of a secondary battery comprising a microcapsule particle, wherein the microcapsule particle comprises:
a core containing a phosphorus-based flame retardant; and
a shell surrounding a surface of the core and comprising a polymer that comprises a urea-derived repeating unit, a formaldehyde-derived repeating unit and a resorcinol-derived repeating unit.

2. The additive for an electrolyte solution of a secondary battery according to claim 1, wherein the shell comprises a urea-formaldehyde-resorcinol terpolymer.

3. The additive for an electrolyte solution of a secondary battery according to claim 1, wherein the phosphorus-based flame retardant comprises a phosphate-based flame retardant or a phosphazene-based flame retardant.

4. The additive for an electrolyte solution of a secondary battery according to claim 3, wherein the phosphazene-based flame retardant comprises a compound represented by Chemical Formula 1: 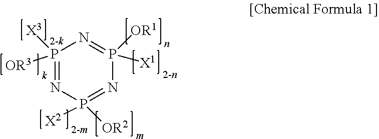
wherein, in Chemical Formula 1, X¹ to X³ are each independently Cl, Br or F, R¹ to R³ are each independently a C₁ to C₆ alkyl group or a C₆ to C₂₀ aryl group, and n, m and k are each independently 0, 1 or 2.

5. The additive for an electrolyte solution of a secondary battery according to claim 3, wherein the phosphate-based flame retardant comprises at least one selected from the group consisting of triphenyl phosphate, trixylenyl phosphate, tricresyl phosphate, triisopropylphenyl phosphate, trischloroethyl phosphate, trischloropropyl phosphate, resorcinyl diphenyl phosphate, phenyl diresorcinyl phosphate, cresyl diphenyl phosphate, xylenyl diphenyl phosphate and phenyl di(isopropylphenyl)phosphate.

6. The additive for an electrolyte solution of a secondary battery according to claim 1, wherein a content of the formaldehyde-derived repeating unit in the polymer is in a range from 20 moles to 100 moles per 1 mole of the resorcinol-derived repeating unit, and a content of the urea-derived repeating unit in the polymer is in a range from 10 moles to 40 moles per 1 mole of the resorcinol-derived repeating unit.

7. The additive for an electrolyte solution of a secondary battery according to claim 1, wherein a particle diameter of the microcapsule particle is in a range from 1 μm to 15 μm.

8. The additive for an electrolyte solution of a secondary battery according to claim 1, wherein the shell has a thickness in a range from 100 nm to 300 nm.

9. The additive for an electrolyte solution of a secondary battery according to claim 1, wherein a content of the core is in a range from 50 weight percent (wt. %) to 80 wt. %, based on a total weight of the microcapsule particle.

10. The additive for an electrolyte solution of a secondary battery according to claim 1, wherein the polymer comprises a structure in which linear chains comprising a plurality of the urea-derived repeating units and the resorcinol-derived repeating units are cross-linked by the formaldehyde-derived repeating unit.

11. A method of preparing an additive for an electrolyte solution of a secondary battery, comprising the steps of:
adding a phosphorus-based flame retardant to a mixture containing urea and resorcinol to prepare a dispersion; and
adding formaldehyde to the dispersion to form microcapsule particles.

12. The method of claim 11, wherein a pH of the mixture is in a range from 3 to 5.

13. The method of claim 11, wherein preparing the dispersion comprises forming preliminary particles that comprise a core containing the phosphorus-based flame retardant and a preliminary shell containing a urea-resorcinol product formed on the core.

14. The method of claim 13, wherein the preliminary particles exist in a colloidal state in the dispersion.

15. The method of claim 13, wherein forming the microcapsule particles comprises converting the preliminary shell into a shell by additionally cross-linking the preliminary shell by formaldehyde.

16. The method of claim 11, wherein forming the microcapsule particles is performed at a temperature ranging from 50° C. to 80° C.

17. An electrolyte solution for a secondary battery, comprising:
an organic solvent;
a lithium salt; and
the additive for an electrolyte solution of a secondary battery of claim 1.

18. The electrolyte solution for a secondary battery according to claim 17, wherein a content of the additive for an electrolyte solution of a secondary battery is in a range from 1 wt. % to 5 wt. %, based on a total weight of the electrolyte solution.

19. A lithium secondary battery, comprising:
a case;
an electrode assembly comprising repeatedly stacked cathodes and anodes; and
the electrolyte solution for a secondary battery of claim 17 accommodated together with the electrode assembly in the case.
